(19) United States
(12) Patent Application Publication
(10) Pub. No.: US 2020/0199357 A1
(43) Pub. Date: Jun. 25, 2020

(54) TALC-FILLED COMPOUND AND THERMOPLASTIC MOLDING MATERIAL

(71) Applicant: Covestro Deutschland AG, Leverkusen (DE)

(72) Inventor: Andreas Seidel, Dormagen (DE)

(21) Appl. No.: 16/621,973

(22) PCT Filed: Jul. 20, 2018
(86) PCT No.: PCT/EP2018/069765

§ 371 Date: Dec. 12, 2019

(30) Foreign Application Priority Data
Jul. 21, 2017 (EP) 17182574.8

(51) Int. Cl. C08L 69/00; C08L 23/20; C08L 51/04; C08K 5/56; B29C 45/00; C08K 3/34

(52) U.S. Cl. CPC C08L 69/005; C08L 23/20; C08L 51/04; B29K 2069/00; B29C 45/0001; C08K 3/34; C08L 2207/53; C08K 5/56

(57) ABSTRACT

Provided is a composition for producing a thermoplastic molding compound. The composition comprises the following: A) 35% to 85% by weight of aromatic polycarbonate, polyester carbonate, and/or polyester, B) 5% to 45% by weight of rubber-modified vinyl (co)polymer having a gel content measured as the proportion insoluble in acetone of 15% to 25% by weight based on the component B, C) 7% to 30% by weight of talc, D) 0.01% to 1% by weight of at least one dihydrogenphosphate salt having a cation selected from the group consisting of aluminum and zinc, and E) 0% to 10% by weight of polymer additives. Also provided is a process for producing a molding compound, a molding compound, a process for producing a molded article, a molded article, an autobody part, and a two-component injection molded part.

The present invention relates to a talc-filled composition, especially a polycarbonate composition, for producing a thermoplastic molding compound, to a process for producing the thermoplastic molding compound, to the molding compound itself, to the use of the composition or molding compound for producing molded articles and to the molded articles themselves.

The molding compound is particularly suitable for use in autobody parts and as a frame material for two-component injection molded parts consisting of an opaque frame and a transparent or translucent window preferably consisting of a polycarbonate composition.

With the aim of reducing vehicle weight and thus ultimately also fuel consumption, increasing efforts are being made in automotive manufacture to substitute metal for plastic because of the simple producibility of automotive plastic parts in injection molding processes and also the greater design freedom and options for function integration. However, thermoplastic compositions for producing automotive parts for interior and exterior applications are generally subject to great technical demands.

For example, thermoplastic molding compounds for production in injection molding processes of large surface area horizontal autobody parts are required to have:
a low coefficient of thermal expansion for high dimensional stability and a lack of warpage to realize low clearances,
a high material stiffness (high modulus of elasticity),
a good melt flowability (low melt viscosity),
a satisfactory mechanical resilience (for example high impact strength),
a high processing stability,
a good surface quality of the unpainted components,
a good paintability to obtain the good surface quality,
a good aging stability in respect of surface quality, composite adhesion to decorative coatings (for example paints) and mechanical material properties under typical usage conditions (for example hot and humid storage).

Comparable properties, but also a mold shrinkage that is very largely isotropically reduced compared to the value for pure polycarbonate, are generally also demanded of thermoplastic polycarbonate molding compounds that are suitable as a composite material, frame material or insert-molding material for the production of two-component injection molded parts consisting of an opaque frame or mounting part and a transparent or translucent window or part section made of a polycarbonate composition. Such parts are used for example in the field of automotive glazing as a glass substitute, but are also suitable for example for the production of lights and headlights in lighting applications, as transilluminated decorative trim in interior lighting (ambient lighting) applications and as transilluminated functional trim or displays for integration of onboard electronics. Such design and functional elements will become increasingly important in the automobile of the future. However, they are also suitable for applications beyond automotive manufacture, for example in home and domestic lighting and for applications in electronic entertainment.

To achieve the low coefficient of thermal expansion, reduced mold shrinkage and increased modulus of elasticity, such compositions often employ minerals as fillers and reinforcers, wherein talc has proven particularly suitable since the use thereof makes it possible to achieve a very largely isotropic reduction in thermal expansion and shrinkage coupled with a comparably high increase in stiffness and good retainment of material strength.

US 2006/0287422 describes thermoplastic polycarbonate compositions containing an impact modifier, optionally a vinyl copolymer, a mineral filler and an acid or an acidic salt which exhibit improved mechanical properties and in which the polycarbonate exhibits an improved thermal integrity of molecular weight.

WO 2008/122359 A1 discloses polycarbonate compositions having improved ductility, heat distortion resistance and processing stability and containing talc, optionally rubber-containing vinyl (co)polymer and a Brønsted acid compound.

WO 2013/060687 A1 discloses polycarbonate compositions stabilized with a Brønsted acid compound having improved processing stability containing optionally rubber-modified vinyl (co)polymer and also optionally talc which are produced in a special process in which the Brønsted-acidic compound is taken up on an inorganic or organic adsorber/absorber, preferably on a finely-divided silica, before compounding.

WO 2010/031513 A1 discloses stress cracking-resistant and low-warpage two-component moldings containing a region formed from a transparent or translucent amorphous polycarbonate molding compound which has been completely or partially insert-molded with an opaque, likewise amorphous thermoplastic composition as the second component, wherein the opaque composition employed as the second component contains polycarbonate, talc and optionally a rubber-containing vinyl (co)polymer.

However, the mechanical characteristics (for example impact strength) of such highly talc-filled polycarbonate compositions are often insufficient for the desired applications, in particular in the case of compositions featuring a particularly high modulus of elasticity and a particularly good melt flowability. Furthermore, realization of high processing stability remains a technical challenge for talc-filled polycarbonate compositions. Such compositions generally have a propensity for decomposition of the polycarbonate to undergo a reduction in the molecular weight and the mechanical properties thereof even under relatively moderate thermal and shear stress but also for formation of surface defects (streaking) on the injection molded parts which are generally prohibitive for visible parts. A further problem for which no adequate solution has hitherto been described is in general that the talc-filled polycarbonate compositions described in the prior art often result in high scrap rates upon painting with water-based paints (for example those based on polyurethanes) as a result of surficial bubble formation in the painting process and/or such bubble formation is especially observed after storage under hot and humid conditions.

It is therefore desirable to provide a composition for producing a thermoplastic molding compound which is suitable
for production by injection molding of large surface area, preferably horizontal, (offline) paintable autobody parts and
as a frame material for producing two-component injection molded parts consisting of an opaque frame or mounting part and a transparent or translucent window or part section made of a polycarbonate composition,
   wherein on account of an improved processing stability of the thermoplastic molding compound the injection molded articles feature an improved surface quality (reduced streaking formation under thermal stress and shearing) and are thus also suitable for parts having class A surface geometry and wherein the parts exhibit a low coefficient of thermal expansion, a very largely isotropic mold shrinkage that is reduced compared to the value for pure polycarbonate, a high stiffness, an improved impact strength and reduced bubble formation after storage under hot and humid conditions (as also occurs for example in painting processes).

The molding compound preferably features a high melt flowability.

The molding compound should preferably also exhibit good heat aging resistance.

It has been found that, surprisingly, the desired profile of properties is exhibited by a composition for producing a thermoplastic molding compound, wherein the composition contains the following constituents:
A) 35% to 85% by weight, preferably 40% to 65% by weight, particularly preferably 45% to 55% by weight, of aromatic polycarbonate, polyester carbonate and/or polyester,
B) 5% to 45% by weight, preferably 15% to 40% by weight, particularly preferably 25% to 35% by weight, of rubber-modified vinyl (co)polymer having a gel content measured as the proportion insoluble in acetone of 15% to 25% by weight, preferably of 18% to 24% by weight, particularly preferably of 20% to 24% by weight, based on the component B,
C) 7% to 30% by weight, preferably 10% to 25% by weight, particularly preferably 15% to 22% by weight of talc,
D) 0.01% to 1% by weight, preferably 0.02% to 0.5% by weight, particularly preferably 0.05% to 0.3% by weight, of at least one dihydrogenphosphate salt having a cation selected from the group consisting of aluminum and zinc and
E) 0% to 10% by weight, preferably 0.1% to 5% by weight, particularly preferably 0.2% to 2% by weight, of polymer additives.

In a preferred embodiment the composition consists to an extent of at least 95% by weight, particularly preferably to an extent of at least 98% by weight, most preferably to an extent of 100% by weight, of the components A to E.

In a preferred embodiment zinc bis(dihydrogenphosphate) is used as component D.

In the most preferred embodiment zinc bis(dihydrogenphosphate) dihydrate Zn(H₂PO₄)₂.2H₂O is used as component D.

In a preferred embodiment component D is employed in the production of the compositions according to the invention in the form of an ideally finely divided powder.

Component A

Employed as component A) is a thermoplastic or a mixture of different thermoplastics selected from at least one polymer of the group consisting of polycarbonate, polyester carbonate and polyester.

In a preferred embodiment, component A) is selected from at least one polymer of the group consisting of polycarbonate and polyester carbonate, more preferably selected from at least one polymer of the group consisting of aromatic polycarbonate and aromatic polyester carbonate, and in a most preferred embodiment component A) is aromatic polycarbonate or a mixture of different aromatic polycarbonates.

In a preferred embodiment component A) is free from polyesters and in a particularly preferred embodiment free from polyesters and polyester carbonates.

According to the invention the term “polycarbonate” is to be understood as meaning both homopolycarbonates and copolycarbonates. These polycarbonates may be linear or branched in the familiar manner. Also employable according to the invention are mixtures of poly carbonates.

A portion, up to 80 mol %, preferably from 20 mol % up to 50 mol %, of the carbonate groups in the polycarbonates employed according to the invention may be replaced by aromatic dicarboxylic ester groups. Such polycarbonates, which contain both acid radicals of carbonic acid and acid radicals of aromatic dicarboxylic acids incorporated into the molecular chain, are referred to as aromatic polyester carbonates.

Replacement of the carbonate groups by the aromatic dicarboxylic ester groups proceeds essentially stoichiometrically and also quantitatively and the molar ratio of the reaction partners is therefore also reflected in the final polyester carbonate. The aromatic dicarboxylic ester groups can be incorporated either randomly or blockwise.

The thermoplastic polycarbonates including the thermoplastic aromatic polyester carbonates have average molecular weights Mw determined by GPC (gel permeation chromatography in methylene chloride with a bisphenol A-based polycarbonate standard) of 15 000 g/mol to 50 000 g/mol, preferably of 20 000 g/mol to 35 000 g/mol, particularly preferably of 23 000 g/mol to 33 000 g/mol.

The production of the polycarbonates and polyester carbonates is carried out in known fashion from diphenols, carbonic acid derivatives and optionally chain terminators and branching agents.

Particulars pertaining to the production of polycarbonates are disclosed in many patent documents spanning approximately the last 40 years. Reference may be made here by way of example to Schnell, “Chemistry and Physics of Polycarbonates”, Polymer Reviews, Volume 9, Interscience Publishers, New York, London, Sydney 1964, to D. Freitag, U. Grigo, P. R. Müller, H. Nouvertné, BAYER AG, “Polycarbonates” in Encyclopedia of Polymer Science and Engineering, Volume 11, Second Edition, 1988, pages 648-718, and finally to U. Grigo, K. Kirchner and P. R. Müller “Polycarbonate” in Becker/Braun, Kunststoff-Handbuch, Volume 3/1, Polycarbonate, Polyacetale, Polyester, Celluloseester, Carl Hanser Verlag Munich, Vienna 1992, pages 117-299.

The production of aromatic polycarbonates is effected for example by reaction of diphenols with carbonic halides, preferably phosgene, and/or with aromatic dicarbonyl dihalides, preferably benzenedicarbonyl dihalides, by the interfacial process, optionally using chain terminators and optionally using trifunctional or more than trifunctional branching agents, production of the polyester carbonates being achieved by replacing a portion of the carbonic acid derivatives with aromatic dicarboxylic acids or derivatives of the dicarboxylic acids, specifically with aromatic dicarboxylic ester structural units according to the carbonate structural units to be replaced in the aromatic polycarbonates. Production via a melt polymerization process by reaction of diphenols with diphenyl carbonate for example is likewise possible.

Dihydroxyaryl compounds suitable for the production of polycarbonates are those of formula (1)

HO—Z—OH (1),

in which
Z is an aromatic radical which has 6 to 30 carbon atoms and may contain one or more aromatic rings, may be substituted and may contain aliphatic or cycloaliphatic radicals or alkylaryls or heteroatoms as bridging elements.

It is preferable when Z in formula (1) represents a radical of formula (2)

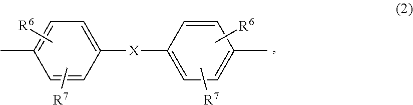

in which
R⁶ and R⁷ independently of one another represent H, C₁- to C₁₈-alkyl, C₁- to C₁₈-alkoxy, halogen such as Cl or Br or in each case optionally substituted aryl- or aralkyl, preferably H or C₁- to C₁₂-alkyl, particularly preferably H or C₁- to C₈-alkyl and very particularly preferably H or methyl, and
X represents a single bond, —SO₂—, —CO—, —O—, —S—, C₁- to C₆-alkylene, C₂- to C₅-alkylidene or C₅- to C₆-cycloalkylidene which may be substituted by C₁- to C₆-alkyl, preferably methyl or ethyl, or else represents C₆- to C₁₂-arylene which may optionally be fused to further aromatic rings containing heteroatoms.

It is preferable when X represents a single bond, C₁- to C₅-alkylene, C₂- to C₅-alkylidene, C₅- to C₆-cycloalkylidene, —O—, —SO—, —CO—, —S—, —SO₂— or a radical of formula (2a)

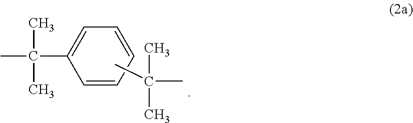

Diphenols suitable for the production of polycarbonates are for example hydroquinone, resorcinol, dihydroxydiphenyls, bis(hydroxyphenyl)alkanes, bis(hydroxyphenyl)cycloalkanes, bis(hydroxyphenyl)sulfides, bis(hydroxyphenyl)ethers, bis(hydroxyphenyl)ketones, bis(hydroxyphenyl)sulfones, bis(hydroxyphenyl)sulfoxides, α,α′-bis(hydroxyphenyl)diisopropylbenzenes, phthalimidines derived from derivatives of isatin or phenolphthalein and the ring-alkylated, ring-arylated and ring-halogenated compounds thereof.

Preferred diphenols are 4,4′-dihydroxydiphenyl, 2,2-bis(4-hydroxyphenyl)propane (bisphenol A), 2,4-bis(4-hydroxyphenyl)-2-methylbutane, 1,1-bis(4-hydroxyphenyl)-p-diisopropylbenzene, 2,2-bis(3-methyl-4-hydroxyphenyl)propane, dimethylbisphenol A, bis(3,5-dimethyl-4-hydroxyphenyl)methane, 2,2-bis(3,5-dimethyl-4-hydroxyphenyl)propane, bis(3,5-dimethyl-4-hydroxyphenyl)sulfone, 2,4-bis(3,5-dimethyl-4-hydroxyphenyl)-2-methylbutane, 1,1-bis(3,5-dimethyl-4-hydroxyphenyl)-p-diisopropylbenzene and 1,1-bis(4-hydroxyphenyl)-3,3,5-trimethylcyclohexane.

Particularly preferred diphenols are 2,2-bis(4-hydroxyphenyl)propane (bisphenol A), 2,2-bis(3,5-dimethyl-4-hydroxyphenyl)propane, 1,1-bis(4-hydroxyphenyl)cyclohexane, 1,1-bis(4-hydroxyphenyl)-3,3,5-trimethylcyclohexane and dimethylbisphenol A.

Greatest preference is given to 2,2-bis(4-hydroxyphenyl)propane (bisphenol A).

These and other suitable diphenols are described for example in U.S. Pat. Nos. 3,028,635, 2,999,825, 3,148,172, 2,991,273, 3,271,367, 4,982,014 and 2,999,846, in DE-A 1 570 703, DE-A 2 063 050, DE-A 2 036 052, DE-A 2 211 956 and DE-A 3 832 396, in FR-A 1 561 518, in the monograph “H. Schnell, Chemistry and Physics of Polycarbonates, Interscience Publishers, New York 1964” and also in JP-A 62039/1986, JP-A 62040/1986 and JP-A 105550/1986.

In the case of homopolycarbonates, only one diphenol is employed and in the case of copolycarbonates, two or more diphenols are employed. The diphenols employed, similarly to all other chemicals and auxiliaries added to the synthesis, may be contaminated with the contaminants originating from their own synthesis, handling and storage. However, it is desirable to use raw materials of the highest possible purity.

Suitable carbonic acid derivatives are for example phosgene or diphenyl carbonate.

Suitable chain terminators that may be employed in the production of polycarbonates are monophenols. Examples of suitable monophenols include phenol itself, alkylphenols such as cresols, p-tert-butylphenol, cumylphenol and mixtures thereof.

Preferred chain terminators are phenols which are mono or polysubstituted with linear or branched, preferably unsubstituted C₁ to C₃₀ alkyl radicals or with tert-butyl. Particularly preferred chain terminators are phenol, cumylphenol and/or p-tert-butylphenol.

The amount of chain terminator to be employed is preferably 0.1 to 5 mol % based on moles of diphenols employed in each case. The addition of the chain terminators may be carried out before, during or after the reaction with a carbonic acid derivative.

Suitable branching agents are the trifunctional or more than trifunctional compounds known in polycarbonate chemistry, in particular those having three or more than three phenolic OH groups.

Suitable branching agents are for example 1,3,5-tri(4-hydroxyphenyl)benzene, 1,1,1-tri(4-hydroxyphenyl)ethane, tri(4-hydroxyphenyl)phenylmethane, 2,4-bis(4-hydroxyphenylisopropyl)phenol, 2,6-bis(2-hydroxy-5′-methylbenzyl)-4-methylphenol, 2-(4-hydroxyphenyl)-2-(2,4-dihydroxyphenyl)propane, tetra(4-hydroxyphenyl)methane, tetra(4-(4-hydroxyphenylisopropyl)phenoxy)methane and 1,4-bis((4′,4″-dihydroxytriphenyl)methyl)benzene and 3,3-bis(3-methyl-4-hydroxyphenyl)-2-oxo-2,3-dihydroindole.

The amount of the branching agents for optional use is preferably 0.05 mol % to 2.00 mol % based on moles of diphenols used in each case.

The branching agents may either be initially charged with the diphenols and the chain terminators in the aqueous alkaline phase or added dissolved in an organic solvent before the phosgenation. In the case of the transesterification process the branching agents are employed together with the diphenols.

Particularly preferred polycarbonates are the homopolycarbonate based on bisphenol A, the homopolycarbonate based on 1,3-bis(4-hydroxyphenyl)-3,3,5-trimethylcyclohexane and the copolycarbonates based on the two monomers bisphenol A and 1,1-bis(4-hydroxyphenyl)-3,3,5-trimethylcyclohexane.

Preferred modes of production of the polycarbonates, including the polyester carbonates, to be used according to the invention are the known interfacial process and the known melt transesterification process (cf. e.g. WO 2004/063249 A1, WO 2001/05866 A1, WO 2000/105867, U.S. Pat. Nos. 5,340,905 A, 5,097,002 A, 5,717,057 A).

In a preferred embodiment suitable polyesters are aromatic, more preferably are polyalkylene terephthalates.

In a particularly preferred embodiment they are reaction products of aromatic dicarboxylic acids or reactive derivatives thereof, such as dimethyl esters or anhydrides, and aliphatic, cycloaliphatic or araliphatic diols and also mixtures of these reaction products.

Particularly preferred aromatic polyalkylene terephthalates contain at least 80% by weight, preferably at least 90% by weight, based on the dicarboxylic acid component of terephthalic acid radicals and at least 80% by weight, preferably at least 90% by weight, based on the diol component of ethylene glycol and/or butane-1,4-diol radicals.

In addition to terephthalic acid radicals the preferred aromatic polyalkylene terephthalates may contain up to 20 mol %, preferably up to 10 mol %, of radicals of other aromatic or cycloaliphatic dicarboxylic acids having 8 to 14 carbon atoms or of aliphatic dicarboxylic acids having 4 to 12 carbon atoms, for example radicals of phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid.

The preferred aromatic polyalkylene terephthalates may contain not only ethylene glycol and/or butane-1,4-diol radicals but also up to 20 mol %, preferably up to 10 mol %, of other aliphatic diols having 3 to 12 carbon atoms or cycloaliphatic diols having 6 to 21 carbon atoms, for example radicals of propane-1,3-diol, 2-ethylpropane-1,3-diol, neopentyl glycol, pentane-1,5-diol, hexane-1,6-diol, cyclohexane-1,4-dimethanol, 3-ethylpentane-2,4-diol, 2-methylpentane-2,4-diol, 2,2,4-trimethylpentane-1,3-diol, 2-ethylhexane-1,3-diol, 2,2-diethylpropane-1,3-diol, hexane-2,5-diol, 1,4-di(β-hydroxyethoxy)benzene, 2,2-bis(4-hydroxycyclohexyl)propane, 2,4-dihydroxy-1,1,3,3-tetramethylcyclobutane, 2,2-bis(4-β-hydroxyethoxyphenyl)propane and 2,2-bis(4-hydroxypropoxyphenyl)propane (DE-A 2 407 674, 2 407 776, 2 715 932).

The aromatic polyalkylene terephthalates may be branched through incorporation of relatively small amounts of tri- or tetrahydric alcohols or tri- or tetrabasic carboxylic acids, for example according to DE-A 1 900 270 and U.S. Pat. No. 3,692,744. Examples of preferred branching agents are trimesic acid, trimellitic acid, trimethylolethane and trimethylolpropane, and pentaerythritol.

Particular preference is given to aromatic polyalkylene terephthalates which have been prepared solely from terephthalic acid and the reactive derivatives thereof (e.g. the dialkyl esters thereof) and ethylene glycol and/or butane-1,4-diol, and to mixtures of these polyalkylene terephthalates.

Preferred mixtures of aromatic polyalkylene terephthalates contain 1% to 50% by weight, preferably 1% to 30% by weight, of polyethylene terephthalate and 50% to 99% by weight, preferably 70% to 99% by weight, of polybutylene terephthalate.

The preferably used aromatic polyalkylene terephthalates have a viscosity number of 0.4 to 1.5 dl/g, preferably 0.5 to 1.2 dl/g, measured in phenol/o-dichlorobenzene (1:1 parts by weight) in a concentration of 0.05 g/ml according to ISO 307 at 25° C. in an Ubbelohde viscometer.

The aromatic polyalkylene terephthalates may be produced by known methods (see, for example, Kunststoff-Handbuch [Plastics Handbook], volume VIII, p. 695 et seq., Carl-Hanser-Verlag, Munich 1973).

Most preferably employed as component A is aromatic polycarbonate based on bisphenol A.

Component B

Component B) is a rubber-modified vinyl (co)polymer.

Component B) comprises one or more graft polymers as component B.1) and one or more rubber-free vinyl (co)polymers not chemically bonded to a rubber and not enclosed in such a rubber as component B.2).

The rubber-modified vinyl (co)polymer of component B) has a gel content measured at room temperature in acetone as the solvent of 15% to 25% by weight, preferably of 18% to 24% by weight, particularly preferably of 20% to 24% by weight (based on the component B) or the sum of all subcomponents from which the component B) is composed).

The gel content of the component B) is determined at 25° C. in a suitable solvent (here in acetone) as described in M. Hoffmann, H. Krömer, R. Kuhn, Polymeranalytik I and II, Georg Thieme-Verlag, Stuttgart (1977) as the proportion insoluble in this solvent. It may alternatively also be calculated from the individual gel contents, determined by precisely this described method, of the individual components from which component B) is composed and the concentrations of the individual components in component B).

Component B.1)

The component B.1) comprises one or more graft polymers of

B.1.1 10% to 95% by weight, preferably 20% to 93% by weight, particularly preferably 25% to 92% by weight, of at least one vinyl monomer and

B.1.2 5% to 90% by weight, preferably 7% to 80% by weight, particularly preferably 8% to 75% by weight, of one or more rubber-like graft substrates preferably having glass transition temperatures <0° C., more preferably <−20° C., particularly preferably <−40° C.,

wherein the polymer chains formed from the monomers B.1.1) are chemically bonded to the graft substrate B.1.2) or are enclosed in the graft substrate such that during production and processing of the compositions according to the invention they do not escape from this graft substrate.

Glass transition temperature is determined by differential scanning calorimetry (DSC) according to the standard DIN EN 61006 (2004 version) at a heating rate of 10 K/min where Tg is defined as the mid-point temperature (tangent method).

Preference is given to particulate graft substrates B.1.2) generally having an average particle size (d50 value) of 0.05 to 10 μm, preferably 0.1 to 2 μm, particularly preferably 0.2 to 1.5 μm.

The average particle size d50 is the diameter above which and below which 50% by weight of the particles respectively lie. It can be determined by ultracentrifugation (W. Scholtan, H. Lange, Kolloid, Z. and Z. Polymere [polymers] 250 (1972), 782-1796).

Monomers B.1.1 are preferably mixtures of

B.1.1.1 50% to 99% by weight, preferably 65% to 85% by weight, preferably 70% to 80% by weight, in each case based on the entirety of the monomers of the graft sheath B.1.1, of vinylaromatics and/or ring-substituted vinylaromatics (such as styrene, α-methylstyrene, p-methylstyrene, p-chlorostyrene) and/or (C1-C8)-alkyl (meth)acrylates, such as methyl methacrylate, ethyl methacrylate and butyl acrylate, and

B.1.1.2 1% to 50% by weight, preferably 15% to 35% by weight, particularly preferably 20% to 30% by weight, in each case based on the entirety of the monomers of the graft sheath B.1.1, of vinyl cyanides (unsaturated nitriles such as acrylonitrile and methacrylonitrile) and/or (C1-C8)-alkyl (meth)acrylates, such as methyl methacrylate, n-butyl acrylate, t-butyl acrylate, and/or derivatives (such as anhydrides and imides) of unsaturated carboxylic acids, for example maleic anhydride and N-phenylmaleimide.

Preferred monomers B.1.1.1 are selected from at least one of the monomers styrene, α-methylstyrene and methyl methacrylate. Preferred monomers B.1.1.2 are selected from at least one of the monomers acrylonitrile, n-butyl acrylate, maleic anhydride and methyl methacrylate.

Particularly preferred monomers are B.1.1.1 styrene and B.1.1.2 acrylonitrile.

Graft substrates B.1.2) suitable for the graft polymers B.1) are for example diene rubbers, EP(D)M rubbers, i.e. those based on ethylene/propylene and optionally diene, acrylate, polyurethane, silicone, chloroprene, and ethylene/vinyl acetate rubbers and also silicone/acrylate composite rubbers.

Preferred graft substrates B.1.2) are diene rubbers, for example based on butadiene and isoprene, or mixtures of diene rubbers or copolymers of diene rubbers or mixtures thereof with further copolymerizable monomers (for example according to B.1.1.1 and B.1.1.2).

Particularly preferred as graft substrate B.1.2) is pure polybutadiene rubber.

Further preferred graft substrates B.1.2) are silicone, acrylate and silicone/acrylate composite rubbers.

Particularly preferred graft polymers B.1) are for example ABS polymers as described for example in DE-OS 2 035 390 (=U.S. Pat. No. 3,644,574) or in DE-OS 2 248 242 (=GB-PS 1 409 275), or in Ullmanns Enzyklopädie der Technischen Chemie, Vol. 19 (1980), p. 280 et seq.

The graft copolymers B.1) are produced by free-radical polymerization, for example by emulsion, suspension, solution or bulk polymerization.

In a preferred embodiment, mixtures of various graft polymers B.1) are used in component B, wherein the graft polymers may differ for example in the mode of production and/or in the nature of the graft substrate B.1.2) and/or in the nature of the graft sheath B.1.1).

As is well known, in grafting the graft monomers B.1.1) are not necessarily completely grafted onto the graft substrate. Products of grafting reactions thus often still contain significant proportions of free (i.e. not chemically bonded to the graft substrate and not irreversibly enclosed in the graft substrate) copolymer having a composition analogous to that of the graft sheath. In the context of the present invention component B.1) is to be understood as meaning exclusively the graft polymer as defined above while the copolymer not chemically bonded to the graft substrate and not enclosed in this graft substrate which is present as a consequence of manufacture is assigned to component B.2).

The proportion of this free copolymer in products of grafting reactions may be determined from the gel contents thereof (proportion of free copolymer=100% by weight−gel content of the product in % by weight), wherein the gel content is determined at 25° C. in a suitable solvent (such as for instance acetone, M. Hoffmann, H. Krömer, R. Kuhn, Polymeranalytik I and II, Georg Thieme-Verlag, Stuttgart 1977) as the proportion of the respective product of the grafting reaction that is insoluble in these solvents.

In a preferred embodiment component B.1) contains polybutadiene-containing rubber particles grafted with the vinyl monomers B.1.1) and containing inclusions of vinyl (co)polymer made of the vinyl monomers B.1.1). In the context of this patent application “inclusion” is to be understood as meaning that the vinyl (co)polymer is included in the rubber particle and cannot be dissolved out by solvents such as acetone.

When the component B contains mixtures of different graft polymers B.1) then in a preferred embodiment this mixture contains a graft polymer B.1) having a core-shell structure in which the core (i.e. the graft substrate) is formed from silicone rubber, acrylate rubber or silicone-acrylate composite rubber.

In a further preferred embodiment the proportion of this graft polymer having a core of silicone rubber, acrylate rubber or silicone-acrylate composite rubber is chosen such that this graft polymer contributes to the gel content measured in acetone of the component B to an extent of at least 70%.

Component B.2)

The composition contains as further component B.2) one or more rubber-free (co)polymers of at least one vinyl monomer, preferably selected from the group of vinylaromatics, vinyl cyanides (unsaturated nitriles), (C1 to C8)-alkyl (meth)acrylates, unsaturated carboxylic acids and derivatives (such as anhydrides and imides) of unsaturated carboxylic acids.

Especially suitable as component B.2) are (co)polymers of

B.2.1) 50% to 99% by weight, preferably 65% to 85% by weight, more preferably 70% to 80% by weight, based on the (co)polymer B.2), of at least one monomer selected from the group of the vinylaromatics (for example styrene, α-methylstyrene), ring-substituted vinylaromatics (for example p-methylstyrene, p-chlorostyrene) and (C1-C8)-alkyl (meth)acrylates (for example methyl methacrylate, n-butyl acrylate, tert-butyl acrylate) and

B.2.2) 1% to 50% by weight, preferably 15% to 35% by weight, more preferably 20% to 30% by weight, based on the (co)polymer B.2), of at least one monomer selected from the group of vinyl cyanides (for example unsaturated nitriles such as acrylonitrile and methacrylonitrile), (C1-C8)-alkyl (meth)acrylates (for example methyl methacrylate, n-butyl acrylate, tert-butyl acrylate), unsaturated carboxylic acids and derivatives of unsaturated carboxylic acids (for example maleic anhydride and N-phenylmaleimide).

These (co)polymers B.2) are resin-like, thermoplastic and rubber-free. Particular preference is given to the copolymer of B2.1) styrene and B2.2) acrylonitrile.

Such (co)polymers B.2) are known and can be prepared by free-radical polymerization, in particular by emulsion, suspension, solution or bulk polymerization.

The (co)polymers B.2) have a weight-average molecular weight (Mw) determined by gel permeation chromatography with a polystyrene standard of preferably 50 000 to 200 000 g/mol, particularly preferably of 70 000 to 170 000 g/mol, very particularly preferably of 80 000 to 130 000 g/mol.

Component C

Naturally occurring or synthetically produced talc is used as component C).

Pure talc has the chemical composition 3 MgO.4SiO2.H2O and thus has an MgO content of 31.9% by weight, an SiO2 content of 63.4% by weight and a content of chemically bonded water of 4.8% by weight. It is a silicate having a layered structure.

Naturally occurring talc materials generally do not have the above-recited ideal composition since they are contaminated through partial replacement of the magnesium by other elements, through partial replacement of silicon by aluminum for example and/or through intergrowth with other minerals, for example dolomite, magnesite and chlorite.

It is preferable to use talc types having a particularly high purity as component C). These are characterized by an MgO content of 28% to 35% by weight, preferably 30% to 33% by weight, particularly preferably 30.5% to 32% by weight, and an SiO2 content of 55% to 65% by weight, preferably 58% to 64% by weight, particularly preferably 60% to 62.5% by weight. Particularly preferred talc types additionally feature an Al2O3 content of less than 5% by weight, particularly preferably less than 1% by weight, especially less than 0.7% by weight.

It is in particular advantageous to use talc in the form of finely ground types having an average particle diameter d50 of <10 μm, preferably <5 μm, particularly preferably <2 μm, very particularly preferably <1.5 μm.

The talc may be surface-treated, for example silanized, to ensure better compatibility with the polymer. With regard to the processing and production of the molding compounds the use of compacted talc is advantageous.

Component D

Employed as component D) is a monophosphate, i.e. a dihydrogenphosphate salt, having a cation selected from the group consisting of aluminum and zinc, preferably zinc bis(dihydrogenphosphate).

In the most preferred embodiment zinc bis(dihydrogenphosphate) dihydrate Zn(H₂PO₄)₂.2H₂O is used as component D).

Component E

As component E) the composition according to the invention may contain one or more polymer additives preferably selected from the group consisting of flame retardants, anti-drip agents, flame retardant synergists, smoke inhibitors, lubricants and demolding agents, nucleating agents, antistats, conductivity additives, stabilizers (e.g. hydrolysis, heat aging and UV stabilizers and also transesterification inhibitors), flow promoters, phase compatibilizers, further impact modifiers distinct from component B) (either with or without a core-shell structure), further polymeric constituents distinct from components A) and B) (for example functional blend partners), fillers and reinforcers distinct from component C) and dyes and pigments.

In a preferred embodiment the composition contains at least one polymer additive selected from the group consisting of lubricants and demolding agents, stabilizers, flow promoters, phase compatibilizers, further impact modifiers, further polymeric constituents, dyes and pigments.

In a preferred embodiment the composition contains pentaerythritol tetrastearate as a demolding agent.

In a preferred embodiment the composition contains as a stabilizer at least one representative selected from the group consisting of sterically hindered phenols, organic phosphites and sulfur-based co-stabilizers.

In a particularly preferred embodiment the composition contains as a stabilizer at least one representative selected from the group consisting of octadecyl 3-(3,5-di-tert-butyl-4-hydroxyphenyl)propionate and tris(2,4-di-tert-butylphenyl) phosphite.

In a particularly preferred embodiment the composition contains as component E) at least one representative selected from the group consisting of lubricants and demolding agents, stabilizers, flow promoters and dyes and pigments and is free from other polymer additives of component E).

In a further preferred embodiment the composition contains as component E) at least one demolding agent, at least one stabilizer and optionally at least one dye and/or one pigment and is free from further polymer additives of component E).

Production of the Molding Compounds and Molded Articles

The compositions according to the invention may be used to produce thermoplastic molding compounds.

The thermoplastic molding compounds according to the invention may be produced for example when the respective constituents of the compositions are in familiar fashion mixed and melt-compounded and melt-extruded at temperatures of preferably 200° C. to 320° C., particularly preferably at 240° C. to 300° C., very particularly preferably at 260° C. to 300° C., in customary apparatuses such as internal kneaders, extruders and twin-screw extruders for example.

In the context of the present application this process is generally referred to as compounding. The term “molding compound” is thus to be understood as meaning the product obtained when the constituents of the composition are melt-compounded and melt-extruded.

The mixing of the individual constituents of the compositions may be carried out in a known manner, either successively or simultaneously, either at about 20° C. (room temperature) or at a higher temperature. This means that for example some of the constituents may be added via the main intake of an extruder and the remaining constituents may be supplied subsequently in the compounding process via an ancillary extruder.

The invention also provides a process for producing the molding compounds according to the invention.

The molding compounds according to the invention may be used to produce molded articles of any kind. These may be produced by injection molding, extrusion and blow-molding processes for example. A further form of processing is the production of molded articles by thermoforming from previously produced sheets or films. The molding compounds according to the invention are particularly suitable for processing by extrusion, blow-molding and thermoforming methods.

The constituents of the compositions may also be metered directly into an injection molding machine or into an extrusion apparatus and processed into molded articles.

Examples of such molded articles that are producible from the compositions and molding compounds according to the invention are films, profiles, housing parts of any kind, for example for domestic appliances such as juice presses, coffee machines, mixers; for office machinery such as monitors, flatscreens, notebooks, printers, copiers; sheets, pipes, electrical installation ducts, windows, doors and other profiles for the construction sector (internal fitout and external applications) and also electrical and electronic components such as switches, plugs and sockets, and parts for commercial vehicles, in particular for the automotive sector. The compositions and molding compounds according to the invention are also suitable for producing the following molded articles or moldings: internal fitout parts for rail vehicles, ships, aircraft, buses and other motor vehicles, bodywork components for motor vehicles, housings of electrical equipment containing small transformers, housings for equipment for the processing and transmission of information, housings and facings for medical equipment, massage equipment and housings therefor, toy vehicles for children, sheetlike wall elements, housings for safety equipment, thermally insulated transport containers, molded parts for sanitation and bath equipment, protective grilles for ventilation openings and housings for garden equipment.

Further embodiments 1 to 27 of the present invention are described hereinbelow:
1. Composition for producing a thermoplastic molding compound, wherein the composition contains the following constituents:
A) 35% to 85% by weight of aromatic polycarbonate, polyester carbonate and/or polyester,
B) 5% to 45% by weight of rubber-modified vinyl (co)polymer having a gel content measured as the proportion insoluble in acetone of 15% to 25% by weight based on the component B,
C) 7% to 30% by weight of talc,
D) 0.01% to 1% by weight of at least one dihydrogenphosphate salt having a cation selected from the group consisting of aluminum and zinc,
E) 0% to 10% by weight of polymer additives.
2. Composition according to embodiment 1 containing
A) 40% to 65% by weight of aromatic polycarbonate, polyester carbonate and/or polyester,
B) 15% to 40% by weight of rubber-modified vinyl (co)polymer having a gel content measured as the proportion insoluble in acetone of 15% to 25% by weight based on the component B,
C) 10% to 25% by weight of talc,
D) 0.02% to 0.5% by weight of at least one dihydrogenphosphate salt having a cation selected from the group consisting of aluminum and zinc,
E) 0.1% to 5% by weight of polymer additives.
3. Composition according to embodiment 2 containing
A) 45% to 55% by weight of aromatic polycarbonate, polyester carbonate and/or polyester,
B) 25% to 35% by weight of rubber-modified vinyl (co)polymer having a gel content measured as the proportion insoluble in acetone of 15% to 25% by weight based on the component B,
C) 15% to 22% by weight of talc,
D) 0.05% to 0.3% by weight of at least one dihydrogenphosphate salt having a cation selected from the group consisting of aluminum and zinc,
E) 0.2% to 2% by weight of polymer additives.
4. Composition according to any of the preceding embodiments, wherein component A is an aromatic polycarbonate.
5. Composition according to embodiment 4, wherein the component A is aromatic polycarbonate based on bisphenol A.
6. Composition according to any of the preceding embodiments, wherein the component B has a gel content measured as the proportion insoluble in acetone of 18% to 24% by weight.
7. Composition according to any of the preceding embodiments, wherein the component B has a gel content measured as the proportion insoluble in acetone of 20% to 24% by weight.
8. Composition according to any of the preceding embodiments, wherein the component B contains polybutadiene-containing rubber particles which are grafted with vinyl monomers and which contain inclusions of vinyl (co)polymer made of the vinyl monomers.
9. Composition according to any of the preceding embodiments, wherein the component B contains graft polymer having a core-shell structure having a core selected from the group consisting of silicone rubber, acrylate rubber and silicone-acrylate composite rubber.
10. Composition according to embodiment 9, wherein the proportion of the graft polymer having a core-shell structure having a core selected from the group consisting of silicone rubber, acrylate rubber and silicone-acrylate composite rubber is chosen such that it contributes to the gel content measured in acetone of the component B to an extent of at least 70%.
11. Compositions according to any of the preceding embodiments, wherein component D is a zinc bis(dihydrogenphosphate).
12. Composition according to embodiment 11, wherein zinc bis(dihydrogenphosphate) in the form of the dihydrate Zn(H₂PO₄)₂.2H₂O is employed as component D.
13. Composition according to any of the preceding embodiments consisting to an extent of at least 95% by weight of the components A-E.
14. Composition according to any of the preceding embodiments consisting to an extent of at least 98% by weight of the components A-E.
15. Composition according to any of the preceding embodiments consisting to an extent of 100% by weight of the components A-E.
16. Process for producing a molding material, wherein the constituents of a composition according to any of embodiments 1 to 15 are mixed with one another at a temperature of 200° C. to 320° C.
17. Process according to embodiment 16, wherein the mixing is effected at 240° C. to 320° C.
18. Process according to embodiment 17, wherein the mixing is effected at 260° C. to 300° C.
19. Molding compound obtained or obtainable by a process according to any of embodiments 16 to 18.
20. Use of a composition according to any of embodiments 1 to 15 or of a molding compound according to embodiment 19 for producing molded articles.
21. Molded article, preferably an autobody part, containing a composition according to any of the embodiments 1 to 15 or a molding compound according to embodiment 19.
22. Autobody part containing thermoplastic molding compounds having a modulus of elasticity according to ISO 527 at 23° C. of at least 4500 MPa, a CLTE_{longitudinal} according to DIN 53752 in the temperature interval of 23-55° C. of not more than 40 ppm/K, a longitudinal shrinkage according to ISO294-4 of not more than 0.4% and an impact strength according to ISO 180/U at 23° C. of at least 60 kJ/m².
23. Part according to embodiment 22, wherein a molding compound according to claim 19 is used as the thermoplastic molding compound.
24. Autobody part according to any of the embodiments 21 to 23, wherein a horizontal autobody part is concerned.
25. Two-component injection molded part consisting of (i) an opaque frame or mounting part produced from a composition according to any of claims 1 to 15 or of a molding compound according to embodiment 19 and (ii) a transparent or translucent window or part section in direct contact with (i).
26. Two-component part according to embodiment 25, wherein (ii) is made of a polycarbonate molding compound.
27. Automotive glazing part, lighting article, headlight, transilluminable decorative or functional trim or display according to embodiment 25 or 26.

### EXAMPLES

Component A:

Linear polycarbonate based on bisphenol A having a weight-average molecular weight Mw of 28 000 g/mol (determined by GPC in methylene chloride against a bisphenol A-polycarbonate standard).

Component B:

Mixture of

B-1) a styrene-acrylonitrile copolymer having an acrylonitrile content of 23% by weight and a weight-average molecular weight M_{w} of 100 000 Da (determined by GPC in tetrahydrofuran with a polystyrene standard,

B-2) an ABS polymer produced by bulk polymerization having an A:B:S weight ratio of 24%:10%:66% having a gel content measured in acetone at room temperature of 19% by weight, wherein the sol fraction of the component B-2 that is soluble in acetone has a weight-average molecular weight M_{w} of 125 000 Da measured by GPC in tetrahydrofuran with a polystyrene as standard and

B-3) a graft polymer produced by emulsion polymerization having a core-shell structure consisting of 75% by weight of a silicone-acrylate composite rubber as the core and 25% by weight of a polymethyl methacrylate shell having a gel content measured in acetone at room temperature of 90% by weight.

As a mixture of these three constituents, the component B has a gel content measured as the fraction insoluble in acetone at room temperature of 23% by weight. This gel fraction of the component B derives to an extent of 22% by weight from the bulk ABS component B-2 and to an extent of 78% by weight from the graft polymer having a core-shell structure B-3. The proportion of the component B-1 is 53% by weight based on B.

Component C:

Jetfine™ 3CA: Talc (Imerys S.A., France)

Component D1:

Fabutit™ 289: orthophosphoric acid absorbed on silica gel (Chemische Fabrik Budenheim KG, Germany). Over 4 h at 23° C. and at a relative humidity of 50% the component D1 exhibits a water absorption of 14% of the starting mass.

Component D2:

Fabutit™ 313: Calcium bis(dihydrogenphosphate) anhydrous=Ca(H₂PO₄)₂ (Chemische Fabrik Budenheim KG, Germany). Over 4 h at 23° C. and at a relative humidity of 50% the component D2 exhibits a water absorption of 1% of the starting mass.

Component D3:

Budit™ T21: Zinc bis(dihydrogenphosphate) dihydrate=Zn(H₂PO₄)₂.2H₂O (Chemische Fabrik Budenheim KG, Germany). Over 4 h at 23° C. and at a relative humidity of 50% the component D3 exhibits a water absorption of 1% of the starting mass.

Component E1:

Irganox™ B900 (BASF, Germany): Stabilizer

(mixture of 80% Irgafos™ 168 (tris(2,4-di-tert-butylphenyl) phosphite) and 20% Irganox™ 1076 (2,6-di-tert-butyl-4-(octadecaneoxycarbonylethyl)phenol) (BASF AG)

Component E2:

Pentaerythritol tetrastearate (demolding agent)

Component E3:

Black Pearls™ 800 (Cabot Corp., Belgium): carbon black pigment

Production of the Molding Compounds and Test Specimens

The components were mixed in a ZSK-25 twin-screw extruder from Coperion (Stuttgart, Germany) at a melt temperature of 260° C. Unless otherwise stated the molded articles were produced at a melt temperature of 260° C. and a mold temperature of 80° C. in an Arburg 270 E injection molding machine.

Testing of the Molding Compounds

The IZOD impact strength was determined at 23° C. on test bars having dimensions of 80 mm×10 mm×4 mm according to ISO 180/U (2013 version).

Total energy absorption in the puncture test according to ISO 6603-2 (2002 version) was used as a measure for material ductility under multiaxial stress. This is performed at 23° C. on test specimens having dimensions of 60 mm×60 mm×2 mm.

Modulus of elasticity E and elongation at break were determined on dumbbells having dimensions of 170 mm×10 mm×4 mm at 23° C. according to ISO 527 (1996 version) at a strain rate of 1 mm/min (modulus of elasticity) or 5 mm/min (elongation at break).

Melt viscosity was determined at a temperature of 260° C. and a shear rate of 1000 s⁻¹ according to ISO 11443 (2014 version).

The coefficient of thermal expansion (CLTE) was determined longitudinally (CLTE_{longitudinal}) and transversely (CLTEₜᵣₐₙₛᵥₑᵣₛₑ) to the melt flow direction in the temperature interval of 23° C. r to 55° C. on test specimens having dimensions of 80 mm×10 mm×4 mm according to DIN 53752 (1980 version) at a heating rate of 3 K/min.

The mold shrinkage was determined longitudinally (longitudinal shrinkage) and transversely (transverse shrinkage) to the melt flow direction according to ISO294-4 (2003 version) on test specimens having dimensions of 60 mm×60 mm×2 mm and manufactured with a holding pressure of 500 bar.

Processing stability was determined via so-called thermal injection testing. Test specimens having dimensions of 60 mm×40 mm×2 mm were injection molded at melting temperatures of 260° C., 280° C. and 300° C. (mold temperature at 80° C. in each case) and assessed for the presence on the sheet surface of streaking as an indication of thermal decomposition.

The sheets produced at 260° C. are furthermore also used for assessment of surface quality. Only parts exhibiting a defect-free and homogeneous surface quality are suitable for class A surfaces.

Assessment of bubble formation under exposure to hot and humid conditions is carried out on the test specimens having dimensions of 60 mm×40 mm×2 mm which were produced using a high-gloss polished mold. These sheets were in each case subjected to a temperature of 40° C. or 90° C. and a relative atmospheric humidity of 95% in each case for three days in a conditioning cabinet. A visual examination was then performed according to the following basis of assessment:

++ no bubbles whatsoever

+ not more than 2 small bubbles per surface (60 mm×40 mm)

− 2 to 5 small bubbles per surface (60 mm×40 mm)

−− more than 5 bubbles per surface (60 mm×40 mm)

TABLE 1
Examples of inventive compositions

| | 1 (V) | 2 (V) | 3 |
|---|---|---|---|
| Composition (parts by weight) | | | |
| A | 49 | 49 | 49 |
| B | 30 | 30 | 30 |
| C | 20 | 20 | 20 |
| D1 | 0.2 | | |
| D2 | | 0.2 | |
| D3 | | | 0.2 |
| E1 | 0.1 | 0.1 | 0.1 |
| E2 | 0.65 | 0.65 | 0.65 |
| E3 | 0.05 | 0.05 | 0.05 |
| Properties | | | |
| Impact strength [kJ/m²] | 52 | 66 | 72 |
| Energy absorption in puncture | 6 | 12 | 12 |
| test [J] | | | |
| Modulus of elasticity [MPa] | 4691 | 4753 | 4685 |
| Elongation at break [%] | 9 | 10 | 12 |
| Melt viscosity [Pas] | 227 | 215 | 228 |
| CLTE_{longitudinal} [ppm/K] | 42 | 38 | 37 |
| CLTEₜᵣₐₙₛᵥₑᵣₛₑ [ppm/K] | 60 | 60 | 59 |
| Longitudinal shrinkage [%] | 0.31 | 0.31 | 0.31 |
| Transverse shrinkage [%] | 0.35 | 0.35 | 0.33 |
| Processing stability | Yes | Yes | No |
| Streaking at 260° C. | | | |
| Streaking at 280° C. | Yes | Yes | No |
| Streaking at 300° C. | Yes | Yes | Yes |
| Surface quality (260° C.) | Streaking | Streaking | Defect-free |
| | | | Homogeneously |
| | | | matt |
| suitable for class A | No | No | Yes |
| Bubble formation (after 3 d at | − | + | ++ |
| 40° C./95% RH) | | | |
| Bubble formation (after 3 d at | −− | + | ++ |
| 90° C./95% RH) | | | |

The data from table 1 show that the inventive composition 3 achieves an advantageous combination of good mechanical and rheological properties, low CLTE, low and isotropic shrinkage and a good stability under hot and humid conditions. When the composition contains the component D3, processing stability is improved and surface quality is suitable for class A. Impact strength and stability under hot and humid conditions are also particularly good.

1. A composition for producing a thermoplastic molding compound,
wherein the composition comprises the following:
A) 35% to 85% by weight of aromatic polycarbonate, polyester carbonate, and/or polyester,
B) 5% to 45% by weight of rubber-modified vinyl (co)polymer having a gel content measured as the proportion insoluble in acetone of 15% to 25% by weight based on the component B,
C) 7% to 30% by weight of talc,
D) 0.01% to 1% by weight of at least one dihydrogenphosphate salt having a cation selected from the group consisting of aluminum and zinc, and
E) 0% to 10% by weight of polymer additives.

2. The composition as claimed in claim 1, wherein component A is aromatic polycarbonate.

3. The composition as claimed in claim 1, wherein the component B comprises polybutadiene-comprising rubber particles which are grafted with vinyl monomers and which contain inclusions of vinyl (co)polymer made of the vinyl monomers.

4. The composition as claimed in claim 1, wherein the component B comprises graft polymer having a core-shell structure having a core selected from the group consisting of silicone rubber, acrylate rubber, and silicone-acrylate composite rubber.

5. The composition as claimed in claim 4, wherein the proportion of the graft polymer having a core-shell structure having a core selected from the group consisting of silicone rubber, acrylate rubber, and silicone-acrylate composite rubber is chosen such that it contributes to the gel content measured in acetone of the component B to an extent of at least 70%.

6. The composition as claimed in claim 1, wherein zinc bis(dihydrogenphosphate) is employed as component D.

7. The composition as claimed in claim 6, wherein zinc bis(dihydrogenphosphate) in the form of the dihydrate Zn(H₂PO₄)₂.2H₂O is employed as component D.

8. A process for producing a molding compound, comprising mixing the constituents of a composition as claimed in claim 1 with one another at a temperature of 200° C. to 320° C.

9. A molding compound obtained or obtainable by a process as claimed in claim 8.

10. A process for producing a molded article comprising utilizing the composition as claimed in claim 1.

11. A molded article, comprising the composition as claimed in claim 1.

12. An autobody part comprising a thermoplastic molding compound having a modulus of elasticity according to ISO 527 at 23° C. of at least 4500 MPa, a CLTE_{longitudinal} according to DIN 53752 in the temperature interval of 23-55° C. of not more than 40 ppm/K, a longitudinal shrinkage according to ISO294-4 of not more than 0.4%, and an impact strength according to ISO 180/U at 23° C. of at least 60 kJ/m².

13. An autobody part comprising a thermoplastic molding compound having a modulus of elasticity according to ISO 527 at 23° C. of at least 4500 MPa, a CLTE_{longitudinal} according to DIN 53752 in the temperature interval of 23-55° C. of not more than 40 ppm/K, a longitudinal shrinkage according to ISO294-4 of not more than 0.4%, and an impact strength according to ISO 180/U at 23° C. of at least 60 kJ/m², wherein a molding compound as claimed in claim 9 is used as the thermoplastic molding compound.

14. A two-component injection molded part consisting of (i) an opaque frame or mounting part produced from a composition as claimed in claim 1 and (ii) a transparent or translucent window or part section in direct contact with (i).

15. The two-component injection molded part of claim 14, wherein the part is an automotive glazing part, lighting article, headlight, or transilluminable decorative or functional trim or display.

16. A process for producing a molded article, comprising utilizing the molding compound as claimed in claim 9.

17. A molded article, comprising the molding compound as claimed in claim 9.

18. The molded article of claim 11, wherein the molded article is an autobody part.

19. The molded article of claim 17, wherein the molded article is an autobody part.

20. A two-component injection molded part consisting of (i) an opaque frame or mounting part produced from a molding compound as claimed in claim 9 and (ii) a transparent or translucent window or part section in direct contact with (i).
